(19) United States
(12) Patent Application Publication
(10) Pub. No.: US 2022/0136850 A1
(43) Pub. Date: May 5, 2022

(54) PROVISION TARGET SEARCH METHOD, PROVISION TARGET DISPLAY METHOD, PROVISION-TARGET-SEARCHING APPARATUS, PROVISION-TARGET-DISPLAYING APPARATUS, AND PROVISION-TARGET-SEARCHING SYSTEM

(71) Applicant: SUMITOMO ELECTRIC INDUSTRIES, LTD., Osaka-shi, Osaka (JP)

(72) Inventor: Kentarou TAKAKI, Osaka-shi (JP)

(73) Assignee: SUMITOMO ELECTRIC INDUSTRIES, LTD., Osaka-shi, Osaka (JP)

(21) Appl. No.: 17/428,236

(22) PCT Filed: Mar. 11, 2019
(86) PCT No.: PCT/JP2019/009622

§ 371 Date: Aug. 3, 2021

(51) Int. Cl. G01C 21/34; G06F 1/28; G06Q 10/02; G06Q 50/06; G01C 21/36

(52) U.S. Cl. CPC G01C 21/3469; G06F 1/28; G01C 21/3679; G06Q 50/06; G06Q 10/02

(57) ABSTRACT

A provision target search method includes a step of finding a path that extends from a first point to a second point via a waypoint that is a charging facility at which a vehicle is charged, based on the first point, the second point, and an amount of remaining power of a drive battery that is included in the vehicle, and a step of searching for a provision target that is providable to a passenger of the vehicle during charging of the vehicle at the waypoint, based on facility information that represents the provision target that is a product or service that is providable at the charging facility.

### TECHNICAL FIELD

The present disclosure relates to a provision target search method, a provision target display method, a provision-target-searching apparatus, a provision-target-displaying apparatus, a provision-target-searching system, and a computer program.

### BACKGROUND ART

In recent years, vehicles that include drive batteries such as an electric vehicle (EV) that includes no engine and that is driven by an electric motor and a plug-in hybrid vehicle (PHV) that is driven by switching between an engine and an electric motor have been widely used for measures against global warming and energy problems such as oil depletion. The widespread use of such vehicles leads to preparation of charging facilities such as charging stands that include chargers for charging the vehicles (see, for example, PTL 1).

### CITATION LIST

### Patent Literature

PTL 1:Japanese Unexamined Patent Application Publication No. 2012-198996

### SUMMARY OF INVENTION

A provision target search method according to an aspect of the present disclosure includes a step of finding a path that extends from a first point to a second point via a waypoint that is a charging facility at which a vehicle is charged, based on the first point, the second point, and an amount of remaining power of a drive battery that is included in the vehicle, and a step of searching for a provision target that is providable to a passenger of the vehicle during charging of the vehicle at the waypoint, based on facility information that represents the provision target that is a product or service that is providable at the charging facility.

A provision target display method according to another aspect of the present disclosure includes a step of notifying a server of a first point, a second point, and an amount of remaining power of a drive battery that is included in a vehicle, a step of acquiring, from the server, a path that extends from the first point to the second point via a waypoint that is a charging facility at which the vehicle is charged, the path being found based on the first point, the second point, and the amount of remaining power, a step of acquiring, from the server, information about a provision target that is a product or service that is providable to a passenger of the vehicle during charging of the vehicle at the waypoint, and a step of displaying the path and the provision target.

A provision-target-searching apparatus according to another aspect of the present disclosure includes a finding unit that finds a path that extends from a first point to a second point via a waypoint that is a charging facility at which a vehicle is charged, based on the first point, the second point, and an amount of remaining power of a drive battery that is included in the vehicle, and a search unit that searches for a provision target that is providable to a passenger of the vehicle during charging of the vehicle at the waypoint, based on facility information that represents the provision target that is a product or service that is providable at the charging facility.

A provision-target-displaying apparatus according to another aspect of the present disclosure includes a notification unit that notifies a server of a first point, a second point, and an amount of remaining power of a drive battery that is included in a vehicle, a path-acquiring unit that acquires, from the server, a path that extends from the first point to the second point via a waypoint that is a charging facility at which the vehicle is charged, the path being found based on the first point, the second point, and the amount of remaining power, a provision-target-information-acquiring unit that acquires, from the server, information about a provision target that is a product or service that is providable to a passenger of the vehicle during charging of the vehicle at the waypoint, and a display control unit that causes the path and the provision target to be displayed on a display screen.

A provision-target-searching system according to another aspect of the present disclosure includes a provision-target-searching apparatus and a provision-target-displaying apparatus. The provision-target-searching apparatus includes a finding unit that finds a path that extends from a first point to a second point via a waypoint that is a charging facility at which a vehicle is charged, based on the first point, the second point, and an amount of remaining power of a drive battery that is included in the vehicle, and a search unit that searches for a provision target that is providable to a passenger of the vehicle during charging of the vehicle at the waypoint, based on facility information that represents the provision target that is a product or service that is providable at the charging facility. The provision-target-displaying apparatus includes a notification unit that notifies the provision-target-searching apparatus of the first point, the second point, and the amount of remaining power of the vehicle, a path-acquiring unit that acquires the path from the provision-target-searching apparatus, a provision-target-information-acquiring unit that acquires a result of searching for the provision target from the provision-target-searching apparatus, and a display control unit that causes the path and the provision target to be displayed on a display screen.

A computer program according to another aspect of the present disclosure is a computer program causing a computer to execute a step of finding a path that extends from a first point to a second point via a waypoint that is a charging facility at which a vehicle is charged, based on the first point, the second point, and an amount of remaining power of a drive battery that is included in the vehicle, and a step of searching for a provision target that is providable to a passenger of the vehicle during charging of the vehicle at the waypoint, based on facility information that represents the provision target that is a product or service that is providable at the charging facility.

A computer program according to another aspect of the present disclosure is a computer program causing a computer to execute a step of notifying a server of a first point, a second point, and an amount of remaining power of a drive battery that is included in a vehicle, a step of acquiring, from the server, a path that extends from the first point to the second point via a waypoint that is a charging facility at which the vehicle is charged, the path being found based on the first point, the second point, and the amount of remaining power, a step of acquiring, from the server, information about a provision target that is a product or service that is providable to a passenger of the vehicle during charging of the vehicle at the waypoint, and a step of displaying the path and the provision target on a display screen.

It goes without saying that the computer programs according to the present disclosure can be distributed by using a non-transitory computer-readable storage medium such as a CD-ROM (Compact Disc-Read Only Memory) or a communication network such as the Internet. The present disclosure can also be achieved as a semiconductor integrated circuit that serves as the provision-target-searching apparatus, the provision-target-displaying apparatus, or part or the whole of the provision-target-searching system.

### BRIEF DESCRIPTION OF DRAWINGS

FIG. 1 illustrates the structure of a provision-target-searching system according to an embodiment of the present disclosure.

FIG. 2 is a block diagram illustrating the structure of a terminal device.

FIG. 3 is a block diagram illustrating the structure of a path-finding server.

FIG. 4 illustrates an example of charging stand information.

FIG. 5 illustrates an example of facility information.

FIG. 6 illustrates an example of reservation status information.

FIG. 7 illustrates examples of a provision target for which a search unit searches.

FIG. 8 is a block diagram illustrating the structure of a provision server.

FIG. 9 is a block diagram illustrating the structure of a delivery server.

FIG. 10 is a flowchart illustrating procedures for processing that is performed by the terminal device.

FIG. 11 is a flowchart illustrating procedures for processing that is performed by the terminal device.

FIG. 12 illustrates an example of path information that is displayed on a screen.

FIG. 13 is a flowchart illustrating procedures for processing that is performed by the path-finding server.

FIG. 14 illustrates an example of transition of the amount of remaining charge of a vehicle that travels along a movement path.

FIG. 15 is a flowchart illustrating procedures for processing that is performed by the provision server.

FIG. 16 is a flowchart illustrating procedures for processing that is performed by the delivery server.

FIG. 17 illustrates an example of the process sequence of the provision-target-searching system.

FIG. 18 illustrates an example of the process sequence of the provision-target-searching system.

FIG. 19A illustrates an example of the movement path of the vehicle when the provision target is reserved.

FIG. 19B illustrates an example of the movement path of the vehicle after the vehicle starts at a start point.

FIG. 20 illustrates an example of the movement path of the vehicle after the vehicle starts at the start point.

FIG. 21A illustrates an example of a plan for a product reservation and the movement path at the start.

FIG. 21B illustrates an example of a change in the product reservation.

FIG. 22 illustrates an example of the process sequence of the provision-target-searching system.

FIG. 23 illustrates an example of the movement path of the vehicle after the vehicle starts at the start point.

FIG. 24 illustrates an example of the process sequence of the provision-target-searching system.

FIG. 25 illustrates an example of the movement path of the vehicle after the product reservation is cancelled.

FIG. 26 illustrates examples of the provision target for which the search unit searches.

### DESCRIPTION OF EMBODIMENTS

### Problems to be Solved by Present Disclosure

The present inventor considers that a vehicle that includes a drive battery has a shorter cruising distance and a longer charging time than those of a gasoline car. Thus, there are needs for the planning of an appropriate path and charging and the effective use of the charging time.

The present disclosure has been accomplished in view of such circumstances, and it is an object of the present disclosure to provide a provision target search method, a provision target display method, a provision-target-searching apparatus, a provision-target-displaying apparatus, a provision-target-searching system, and a computer program that enable the planning of the appropriate path and charging and the effective use of the charging time to be achieved at the same time.

### Advantageous Effects of Present Disclosure

According to the present disclosure, the planning of the appropriate path and charging and the effective use of the charging time can be achieved at the same time.

### Summary of Embodiments of Present Disclosure

Summaries of embodiments of the present disclosure will be first listed and described.

(1) A provision target search method according to an embodiment of the present disclosure includes a step of finding a path that extends from a first point to a second point via a waypoint that is a charging facility at which a vehicle is charged, based on the first point, the second point, and an amount of remaining power of a drive battery that is included in the vehicle, and a step of searching for a provision target that is providable to a passenger of the vehicle during charging of the vehicle at the waypoint, based on facility information that represents the provision target that is a product or service that is providable at the charging facility.

This feature enables the path that extends via the waypoint that is the charging facility to be found and enables the provision target that is providable to the passenger during charging of the vehicle to be searched for. Thus, the planning of the appropriate path and charging and the effective use of the charging time can be achieved at the same time.

(2) The step of finding the path preferably includes finding the path that extends via the waypoint for charging under a constraint that the amount of remaining power does not become less than a predetermined power threshold.

This feature enables the vehicle to be prevented from being unable to travel because the amount of remaining power decreases while the vehicle travels halfway.

(3) The step of finding the path more preferably further includes calculating a charging time during which the vehicle is charged at the waypoint, and the step of searching for the provision target more preferably further includes searching for the provision target, based on the charging time and a consumption time that is consumed to provide the provision target.

This feature enables the provision target that has the consumption time corresponding to the charging time to be provided to the passenger. For example, the provision target that has the consumption time closest to the charging time is provided to the passenger, and consequently, the passenger can effectively use the charging time.

(4) The step of searching for the provision target may further include searching for the provision target, based on an advertising cost of the provision target.

For example, this feature enables the provision target that is prioritized to be provided to a user. Thus, the user can readily select the provision target.

(5) The provision target search method described above may further include a step of displaying the path and the provision target on a display screen.

This feature enables the user to know the provision target that is provided at the charging facility on the path.

(6) The provision target search method described above may further include a step of accepting a reservation for the provision target from a predetermined user, and a step of notifying a provider who provides the provision target of the provision target that is reserved and an estimated time of arrival at the charging facility at which the provision target is providable.

This feature enables the provider to know in advance the reservation for the provision target and the estimated time at which the passenger of the vehicle arrives. Thus, the provider can prepare the provision target in good time for the estimated time at which the passenger arrivals. An example of the predetermined user is a user who is registered in advance in a path-finding server that finds the path or in a provision server that performs a process for providing the provision target.

(7) The step of finding the path may further include finding a path that extends from a current position to the second point via the waypoint that is the charging facility at which the provision target that is reserved by the predetermined user is providable, based on the current position of the vehicle.

This feature enables the reserved provision target to be provided to the passenger of the vehicle, for example, even in the case where the vehicle deviates from the path.

(8) The step of notifying the provider may include, in a case where the estimated time of arrival is changed, again notifying the provider of a changed estimated time of arrival.

This feature enables the provider to be notified of the latest estimated time of arrival. Thus, the provider can prepare the provision target in good time for the latest estimated time of arrival.

(9) The provision target search method described above may further include a step of accepting a change in the provision target from the predetermined user, and a step of notifying the provider of a provision target changed.

This feature enables the provider to make preparation depending on the change in the case where the provision target is changed.

(10) The provision target search method described above may further include a step of accepting a change in the second point from the predetermined user. The step of finding the path may include, in a case where the change in the second point is accepted, again finding a path that extends to the second point via the waypoint that is the charging facility at which the provision target is providable.

This feature enables the reserved provision target to be provided to the passenger of the vehicle even in the case where the second point is changed.

(11) A provision target display method according to another embodiment of the present disclosure includes a step of notifying a server of a first point, a second point, and an amount of remaining power of a drive battery that is included in a vehicle, a step of acquiring, from the server, a path that extends from the first point to the second point via a waypoint that is a charging facility at which the vehicle is charged, the path being found based on the first point, the second point, and the amount of remaining power, a step of acquiring, from the server, information about a provision target that is a product or service that is providable to a passenger of the vehicle during charging of the vehicle at the waypoint, and a step of displaying the path and the provision target.

This feature enables the path that extends via the waypoint that is the charging facility and the provision target that is providable to the passenger of the vehicle during charging of the vehicle to be provided to the passenger. Thus, the planning of the appropriate path and charging and the effective use of the charging time can be achieved at the same time.

(12) The step of acquiring the path preferably includes acquiring the path that extends via the waypoint for charging and that is found under a constraint that the amount of remaining power does not become less than a predetermined power threshold.

This feature enables the vehicle to be prevented from being unable to travel because the amount of remaining power decreases in the middle of driving.

(13) The step of acquiring the information about the provision target more preferably includes acquiring the information about the provision target by searching based on a charging time of the vehicle at the waypoint and a consumption time that is consumed to provide the provision target.

This feature enables the provision target that has a provision time corresponding to the charging time to be provided to the passenger of the vehicle. For example, the provision target that has the provision time closest to the charging time is provided to the passenger, and consequently, the passenger can effectively use the charging time.

(14) The step of acquiring the information about the provision target may include acquiring the information about the provision target by searching based on an advertising cost of the provision target.

For example, this feature enables the provision target that is prioritized to be provided to the user. Thus, the user can readily select the provision target.

(15) The provision target display method described above may further include a step of accepting a reservation for the provision target from a predetermined user, and a step of notifying a provider who provides the provision target of the reserved provision target and an estimated time of arrival at the charging facility at which the provision target is providable.

This feature enables the provider to know in advance the reservation for the provision target and the estimated time at which the passenger of the vehicle arrives. Thus, the provider can prepare the provision target in good time for the estimated time at which the passenger arrivals. An example of the predetermined user is a user who is registered in advance in the path-finding server that finds the path or in the provision server that performs a process for providing the provision target.

(16) The provision target display method described above may further include a step of notifying the server of a current position of the vehicle. The step of acquiring the path may further include acquiring, from the server, a path that extends from the current position to the second point via the waypoint that is the charging facility at which the provision target that is reserved by the predetermined user is providable.

This feature enables the reserved provision target to be provided to the passenger of the vehicle even in the case where the vehicle deviates from the path.

(17) The step of notifying the provider may include, in a case where the estimated time of arrival is changed, again notifying the provider of a changed estimated time of arrival.

This feature enables the provider to be notified of the latest estimated time of arrival. Thus, the provider can prepare the provision target in good time for the latest estimated time of arrival.

(18) The provision target display method described above may further include a step of accepting a change in the provision target from the predetermined user, and a step of notifying the provider of a provision target changed.

This feature enables the provider to make preparation depending on the change in the case where the provision target is changed.

(19) The provision target display method described above may further include a step of notifying the server of the second point that is changed by a user input. The step of acquiring the path may include, in a case where the second point is changed, again acquiring a path that extends to the second point via the waypoint that is the charging facility at which the provision target is providable.

This feature enables the reserved provision target to be provided to the passenger of the vehicle even in the case where the second point is changed.

(20) A provision-target-searching apparatus according to another embodiment of the present disclosure includes a finding unit that finds a path that extends from a first point to a second point via a waypoint that is a charging facility at which a vehicle is charged, based on the first point, the second point, and an amount of remaining power of a drive battery that is included in the vehicle, and a search unit that searches for a provision target that is providable to a passenger of the vehicle during charging of the vehicle at the waypoint, based on facility information that represents the provision target that is a product or service that is providable at the charging facility.

This structure includes processing units related to the characteristic steps that are included in the provision target search method described above. Thus, the same actions and effects as those of the provision target search method described above can be achieved.

(21) A provision-target-displaying apparatus according to another embodiment of the present disclosure includes a notification unit that notifies a server of a first point, a second point, and an amount of remaining power of a drive battery that is included in a vehicle, a path-acquiring unit that acquires, from the server, a path that extends from the first point to the second point via a waypoint that is a charging facility at which the vehicle is charged, the path being found based on the first point, the second point, and the amount of remaining power, a provision-target-information-acquiring unit that acquires, from the server, information about a provision target that is a product or service that is providable to a passenger of the vehicle during charging of the vehicle at the waypoint, and a display control unit that causes the path and the provision target to be displayed on a display screen.

This structure includes processing units related to the characteristic steps that are included in the provision target display method described above. Thus, the same actions and effects as those of the provision target display method described above can be achieved.

(22) A provision-target-searching system according to another embodiment of the present disclosure includes a provision-target-searching apparatus and a provision-target-displaying apparatus. The provision-target-searching apparatus includes a finding unit that finds a path that extends from a first point to a second point via a waypoint that is a charging facility at which a vehicle is charged, based on the first point, the second point, and an amount of remaining power of a drive battery that is included in the vehicle, and a search unit that searches for a provision target that is providable to a passenger of the vehicle during charging of the vehicle at the waypoint, based on facility information that represents the provision target that is a product or service that is providable at the charging facility. The provision-target-displaying apparatus includes a notification unit that notifies the provision-target-searching apparatus of the first point, the second point, and the amount of remaining power of the vehicle, a path-acquiring unit that acquires the path from the provision-target-searching apparatus, a provision-target-information-acquiring unit that acquires a result of searching for the provision target from the provision-target-searching apparatus, and a display control unit that causes the path and the provision target to be displayed on a display screen.

This structure enables the path that extends via the waypoint that is the charging facility to be found and enables the provision target that is providable to the passenger during charging of the vehicle to be searched for. Thus, the planning of the appropriate path and charging and the effective use of the charging time can be achieved at the same time.

(23) A computer program according to another embodiment of the present disclosure is a computer program causing a computer to execute a step of finding a path that extends from a first point to a second point via a waypoint that is a charging facility at which a vehicle is charged, based on the first point, the second point, and an amount of remaining power of a drive battery that is included in the vehicle, and a step of searching for a provision target that is providable to a passenger of the vehicle during charging of the vehicle at the waypoint, based on facility information that represents the provision target that is a product or service that is providable at the charging facility.

This feature enables the computer to perform the provision target search method described above. Thus, the same actions and effects as those of the provision target search method described above can be achieved.

(24) A computer program according to another embodiment of the present disclosure is a computer program causing a computer to execute a step of notifying a server of a first point, a second point, and an amount of remaining power of a drive battery that is included in a vehicle, a step of acquiring, from the server, a path that extends from the first point to the second point via a waypoint that is a charging facility at which the vehicle is charged, the path being found based on the first point, the second point, and the amount of remaining power, a step of acquiring, from the server, information about a provision target that is a product or service that is providable to a passenger of the vehicle during charging of the vehicle at the waypoint, and a step of displaying the path and the provision target on a display screen.

This feature enables the computer to perform the provision target display method described above. Thus, the same actions and effects as those of the provision target display method described above can be achieved.

### Detail of Embodiments of Present Disclosure

Embodiments of the present disclosure will now be described with reference to the drawings. The embodiments described below are preferred examples of the present disclosure. Numerical values, shapes, materials, elements, the arrangement and connection form of the elements, steps, the order of the steps, for example, described below are examples according to the embodiments and do not limit the present disclosure. Among the elements according to the embodiments below, elements that are not recited in the independent claims that define the broadest concept of the present disclosure are described as optional elements that are included as preferred aspects.

### <Structure of Provision-Target-Searching System>

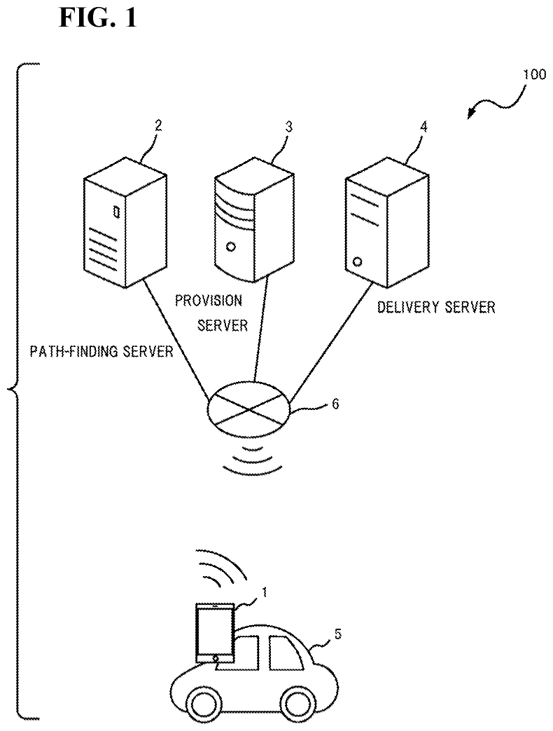

FIG. 1 illustrates the structure of a provision-target-searching system according to the embodiment of the present disclosure.

A provision-target-searching system 100 includes a terminal device 1, a path-finding server 2, a provision server 3, and a delivery server 4. The terminal device 1, the path-finding server 2, the provision server 3, and the delivery server 4 are connected to each other via a network 6 such as the Internet. Any two or all of the servers of the path-finding server 2, the provision server 3, and the delivery server 4 may be integrated into the same server.

The terminal device 1 is used by a predetermined user, that is, a user of a vehicle 5 such as an electric vehicle that includes a drive battery, and examples of the terminal device 1 include a smartphone and an onboard device. Information (for example, a user ID) about the user who uses the terminal device 1 is preferably registered in advance in the path-finding server 2 and the provision server 3. This enables the path-finding server 2 and the provision server 3 to identify the user who uses the terminal device 1.

The path-finding server 2 provides the terminal device 1 with information about a movement path that extends to the destination of the vehicle 5 and information about a product or service (referred to below as a “provision target”) that is providable to a passenger of the vehicle 5 at a waypoint on the movement path. The waypoint according to the present embodiment is a charging facility such as a charging stand at which the battery of the vehicle 5 can be charged. In the description below, the passenger of the vehicle 5 is the same as the user who uses the terminal device 1. Thus, the passenger of the vehicle 5 to which the provision target is provided and the user who uses the terminal device 1 are not distinguished and are referred to as the user. However, the passenger of the vehicle 5 may differ from the user who uses the terminal device 1.

The provision server 3 performs a process of providing the provision target to the user at the waypoint. For example, the provision server 3 transmits an instruction for preparing food to a location at which the food is cooked in the case where the food is provided to the user or transmits an instruction for reserving a massage to a location at which the massage is provided in the case where a massage service is provided to the user.

When the provision target is provided at the waypoint, if it is necessary for a vehicle to deliver the provision target or it is necessary for a vehicle to transport the user to a location at which the provision target is provided, the delivery server 4 performs a process for delivery or transportation. For example, in the case where the charging stand is away from the location at which the food is cooked, and the user wishes the delivery of the food to the charging stand, the delivery server 4 instructs, for example, a delivery service to deliver the food in time for the estimated time at which the user arrives at the charging stand.

### <Structure of Terminal Device>

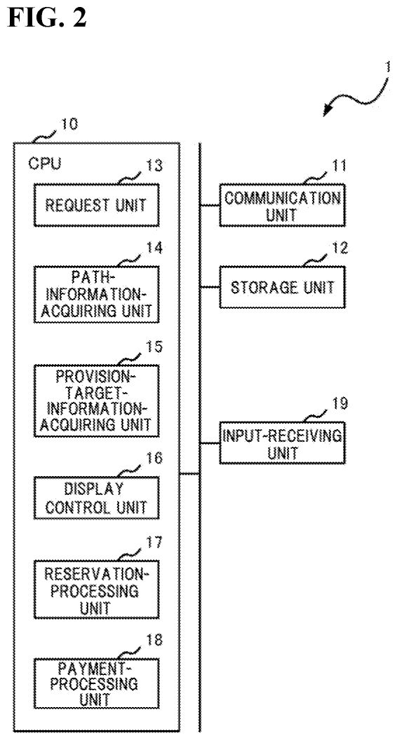

FIG. 2 is a block diagram illustrating the structure of the terminal device 1.

The terminal device 1 functions as the provision-target-displaying apparatus and includes a CPU (Central Processing Unit) 10, a communication unit 11, a storage unit 12, and an input-receiving unit 19.

The communication unit 11 includes a wireless communication interface for connecting the terminal device 1 to the network 6.

The storage unit 12 is a storage device for storing a computer program that is performed by the CPU 10 or various kinds of data such as temporary data when the computer program is performed, and the storage unit 12 includes, for example, a non-volatile memory, a volatile memory, or a magnetic disk.

The input-receiving unit 19 accepts various inputs from the user. For example, the input-receiving unit 19 includes a touch screen.

The CPU 10 includes a request unit 13, a path-information-acquiring unit 14, a provision-target-information-acquiring unit 15, a display control unit 16, a reservation-processing unit 17, and a payment-processing unit 18 that serve as functional processing units that are provided by reading and running the computer program that is stored in the storage unit 12 by the CPU 10.

The request unit 13 performs a process of making a request for finding a path that extends from a first point to a second point. For example, the request unit 13 acquires information about the start point and destination of the vehicle 5 as the first point and the second point by a user input. The request unit 13 may acquire the amount of remaining power (the “amount of remaining power” is also referred to below as the “amount of remaining charge”) of the drive battery that is mounted in the vehicle 5 by a user input or may acquire the amount of remaining power by communicating with an onboard device such as an ECU (Electronic Control Unit). The communication may be based on, for example, the specification of a Smart Device Link (registered trademark). The request unit 13 transmits path finding request information including information about the start point, the destination, and the amount of remaining charge to the path-finding server 2 via the communication unit 11. The start point and the destination may be represented by latitude and longitude or may be represented by, for example, a facility identifier.

The request unit 13 functions as a notification unit, acquires the current position of the vehicle 5 from, for example, a GPS receiver that is mounted in the vehicle 5, and transmits current position information that represents the acquired current position to the path-finding server 2 via the communication unit 11. The current position is represented by, for example, latitude and longitude.

The path-information-acquiring unit 14 functions as a path-acquiring unit and acquires path information about a path that extends from the start point or the current position to the destination from the path-finding server 2 via the communication unit 11. The path information includes information about the movement path that extends to the destination via the waypoint that is the charging stand at which the vehicle 5 is charged in consideration for the amount of remaining charge. That is, the vehicle 5 is charged at the charging stand that is the waypoint.

The provision-target-information-acquiring unit 15 acquires information about the provision target that is providable at the waypoint described above from the path-finding server 2 via the communication unit 11. For example, in the case where there is a fast food restaurant together with the charging stand, the provision-target-information-acquiring unit 15 acquires information about providable food.

The display control unit 16 controls display of the path information that is acquired by the path-information-acquiring unit 14 and provision target information that is acquired by the provision-target-information-acquiring unit 15 on a screen of a display device.

The reservation-processing unit 17 performs a process related to the reservation for the provision target that is selected by the user from the provision target information. For example, in the case where the user wishes the reservation for the provision target, the reservation-processing unit 17 transmits reservation information for reserving the wished provision target to the provision server 3 and the path-finding server 2 via the communication unit 11. The reservation information includes information about the reserved provision target, a charging station at which the provision target is provided, and the estimated time of arrival at the charging station.

In the case where the user wishes to change the reservation for the provision target or to cancel the reservation, the reservation-processing unit 17 transmits reservation change information for changing or canceling the reservation to the provision server 3 via the communication unit 11. The reservation change information includes information about, for example, the provision target that is to be changed or cancelled, the number of the provision target, and a changed time.

The payment-processing unit 18 performs a process for paying the price of the provision target that is reserved by the user. For example, the payment-processing unit 18 communicates with a payment server of a credit card company for payment.

### <Structure of Path-Finding Server>

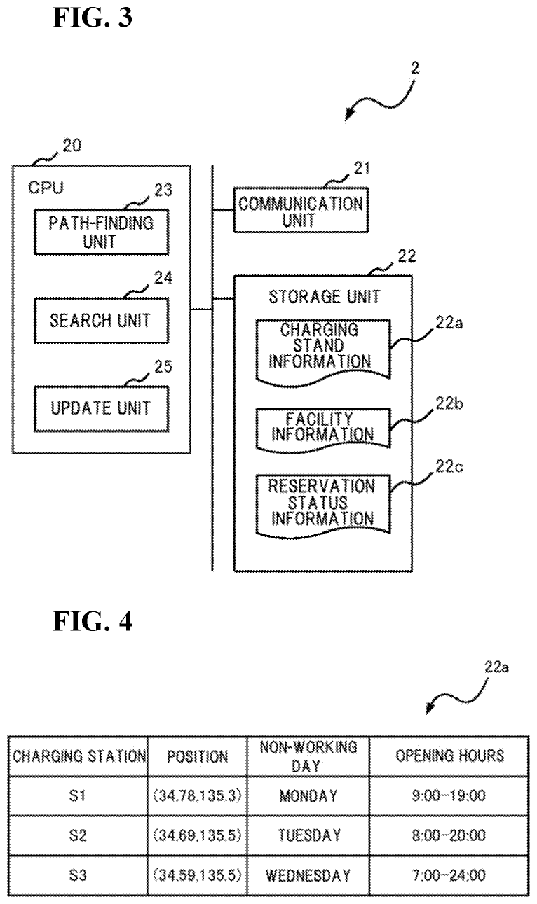

FIG. 3 is a block diagram illustrating the structure of the path-finding server 2. The path-finding server 2 functions as the provision-target-searching apparatus and includes a CPU 20, a communication unit 21, and a storage unit 22.

The communication unit 21 includes a wireless communication interface or a wired communication interface for connecting the path-finding server 2 to the network 6.

The storage unit 22 is a storage device for storing a computer program that is performed by the CPU 20 or various kinds of data, and the storage unit 22 includes, for example, a non-volatile memory, a volatile memory, or a magnetic disk.

The storage unit 22 stores charging stand information 22a, facility information 22b, and reservation status information 22c.

FIG. 4 illustrates an example of the charging stand information 22a. The charging stand information 22a represents the name, position, non-working day and opening hours of the charging station.

For example, a charging station “S1” is located at a position (34.78, 135.3), the non-working day is “Monday”, and the opening hours are 9:00 to 19:00. A charging station “S2” is located at a position (34.69, 135.5), the non-working day is “Tuesday”, and the opening hours are 8:00 to 20:00. A charging station “S3” is located at a position (34.59, 135.5), the non-working day is “Wednesday”, and the opening hours are 7:00 to 24:00. A position (N, E) represents north latitude N and east longitude E.

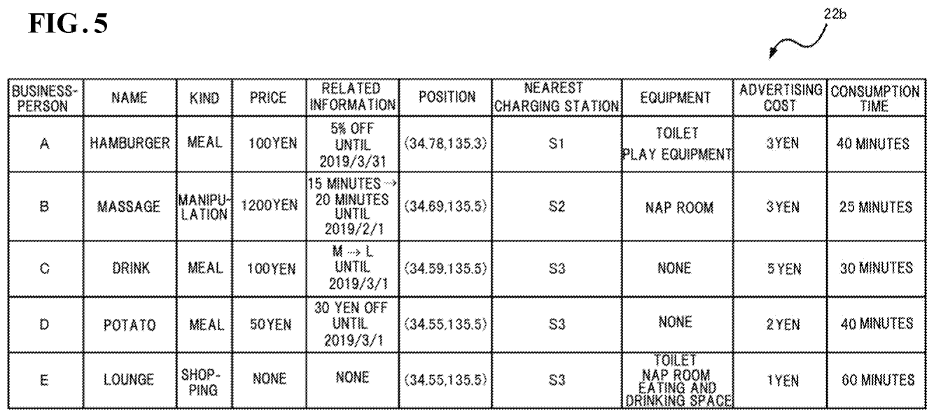

FIG. 5 illustrates an example of the facility information 22b. The facility information 22b is related to a nearest facility to the charging station. The facility information 22b represents the businessperson of the facility, the name of the provision target that is provided at the facility, the kind of the provision target, the price of the provision target, related information about the provision target, the position of the facility, the nearest charging station to the facility, equipment that is installed in the facility, an advertising cost that is paid per provision of the provision target to the user, and a standard consumption time that is consumed to provide the provision target. An example of the related information about the provision target is coupon information such as a discount.

For example, the provision target that is provided at the facility that is run by a businessperson “A” is a “hamburger”, the kind thereof is a “meal”, the price is “100 yen”, and related information about the facility is “5% off until 2019/3/31”. The facility is located at the position (34.78, 135.3), the nearest charging station is “S1”, the equipment includes a “toilet” and “play equipment”, the advertising cost is “3 yen”, and the consumption time is “40 minutes”.

The provision target that is provided at the facility that is run by a businessperson “B” is a “massage”, the kind thereof is a “manipulation”, the price is “1200 yen”, and related information about the facility is “15 minutes→20 minutes until 2019/2/1”. The facility is located at the position (34.69, 135.5), the nearest charging station is “S2”, the equipment includes a “nap room”, the advertising cost is “3 yen”, and the consumption time is “25 minutes”.

The provision target that is provided at the facility that is run by a businessperson “C” is a “drink”, the kind thereof is a “meal”, the price is “100 yen”, and related information about the facility is “M→L until 2019/3/1”. The facility is located at the position (34.59, 135.5), the nearest charging station is “S3”, there is no equipment, the advertising cost is “5 yen”, and the consumption time is “30 minutes”.

The provision target that is provided at the facility that is run by a businessperson “D” is a “potato”, the kind thereof is a “meal”, the price is “50 yen”, and related information about the facility is “30 yen off until 2019/3/1”. The facility is located at a position (34.55, 135.5), the nearest charging station is “S3”, there is no equipment, the advertising cost is “2 yen”, and the consumption time is “40 minutes”.

The provision target that is provided at the facility that is run by a businessperson “E” is a “lounge”, the kind thereof is “shopping”, there is no price, and there is no related information. The facility is located at the position (34.55, 135.5), the nearest charging station is “S3”, the equipment includes a “toilet”, a “nap room”, and an “eating and drinking space”, the advertising cost is “1 yen”, and the consumption time is “60 minutes”.

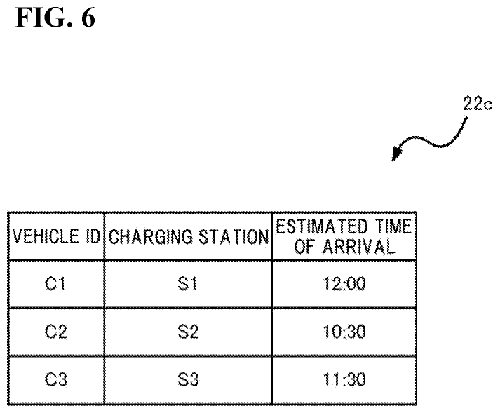

FIG. 6 illustrates an example of the reservation status information 22c. The reservation status information 22c is information, for each vehicle 5, that represents the nearest charging station to the location at which the provision target that is reserved by the user of the vehicle 5 is provided and the estimated time of arrival at the charging station.

For example, it is represented that the vehicle 5 that has a vehicle ID “C1” will arrive at the charging station “S1” at “12:00”. It is represented that the vehicle 5 that has a vehicle ID “C2” will arrive at the charging station “S2” at “10:30”. It is represented that the vehicle 5 that has a vehicle ID “C3” will arrive at the charging station “S3” at “11:30”.

Referring to FIG. 3 again, the CPU 20 includes a path-finding unit 23, a search unit 24, and an update unit 25 that serve as functional processing units that are provided by reading and running the computer program that is stored in the storage unit 22 by the CPU 20.

The path-finding unit 23 receives the path finding request information from the terminal device 1 via the communication unit 21. The path-finding unit 23 finds the movement path that extends from the start point to the destination via the waypoint that is the charging station, based on the received path finding request information such that the amount of remaining charge of the drive battery that is mounted in the vehicle 5 does not become less than a predetermined power threshold when the vehicle 5 moves from the start point that is represented by the path finding request information to the destination. At this time, the path-finding unit 23 calculates a charging time that is required for charging up to a predetermined upper threshold from the amount of remaining charge of the vehicle 5 that is predicted when the vehicle 5 arrives at the charging station. The path can be found by using, for example, a known path finding method such as the Dijkstra's algorithm or the A* finding algorithm.

The path-finding unit 23 transmits the path information including the found movement path and the charging time at the waypoint to the terminal device 1 via the communication unit 21.

The path-finding unit 23 acquires the current position information of the terminal device 1 from the terminal device 1 via the communication unit 21 after the vehicle 5 travels, and finds a path that extends from the current position that is represented by the current position information to the destination. At this time, in the case where the reservation status information 22c represents that the vehicle 5 moves via the charging station, the path-finding unit 23 refers to the reservation status information 22c and finds a path that extends via the charging station.

The search unit 24 searches for the provision target that is providable at the waypoint that is found by the path-finding unit 23, based on the facility information 22b. For example, suppose that the search unit 24 finds the charging stations S1, S2, and S3 as candidates for the waypoint. The search unit 24 searches for a single provision target that has a high advertising cost among providable provision targets for each charging station. The search unit 24 may search for a predetermined number of provision targets in descending order of the advertising cost.

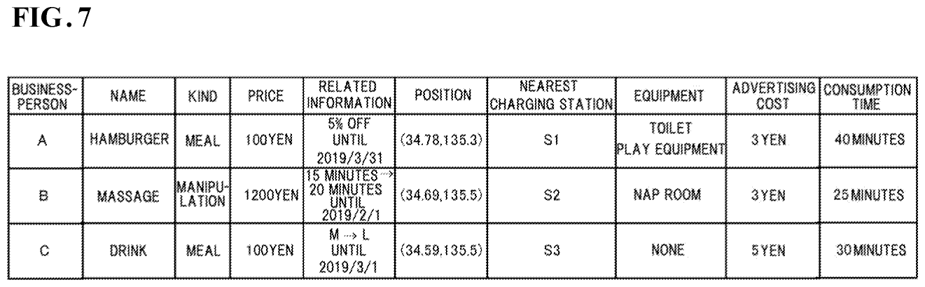

FIG. 7 illustrates examples of the provision target for which the search unit 24 searches. The search unit 24 selects the provision targets the nearest charging stations of which are S1, S2, and S3 from the facility information 22b illustrated in FIG. 5. Consequently, the provision targets of the businesspeople A to E are selected. Subsequently, the search unit 24 selects the provision target the advertising cost of which is highest for each charging station. For example, the search unit 24 selects the provision targets of the businesspeople A, B, and C from the provision targets that are providable at the charging stations S1, S2, and S3.

The search unit 24 transmits the provision target information that represents the searched provision targets to the terminal device 1 via the communication unit 21.

Referring to FIG. 3 again, the update unit 25 performs a process of updating the reservation status information 22c that is stored in the storage unit 22. Specifically, the update unit 25 receives the reservation information about the provision target from the terminal device 1 via the communication unit 21 and adds, to the reservation status information 22c, the charging station and the estimated time of arrival at the charging station that are represented by the received reservation information and the vehicle ID of the vehicle 5 in which the terminal device 1 that transmits the reservation information is mounted. The terminal device 1 may transmit the vehicle ID when the reservation information is transmitted or may transmit the ID of the terminal device 1 instead of the vehicle ID.

The update unit 25 receives changeable information from the provision server 3 via the communication unit 21. The changeable information relates to a change in the provision target or a cancel thereof and represents, for example, the changed or cancelled provision target, the charging station that is the location at which the provision target is provided, the changed estimated time of arrival at the charging station, and the vehicle ID of the vehicle 5 in which the terminal device 1 that cancels the provision target is mounted.

In the case where the changeable information represents that the provision target is cancelled, the update unit 25 deletes a record that contains the vehicle ID and the charging station that are represented by the changeable information from the reservation status information 22c. In the case where the changeable information represents that the estimated time of arrival is changed, the update unit 25 updates the reservation status information 22c, based on the vehicle ID, the charging station, and the changed estimated time of arrival that are represented by the changeable information.

### <Structure of Provision Server>

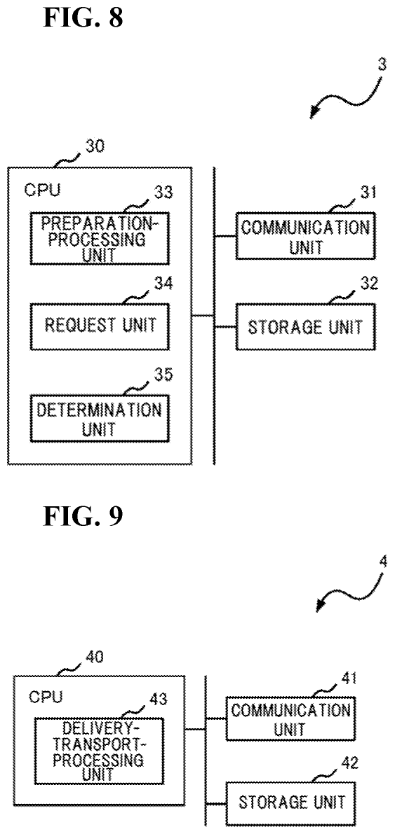

FIG. 8 is a block diagram illustrating the structure of the provision server 3.

The provision server 3 includes a CPU 30, a communication unit 31, and a storage unit 32.

The communication unit 31 includes a wireless communication interface or a wired communication interface for connecting the provision server 3 to the network 6.

The storage unit 32 is a storage device for storing a computer program that is performed by the CPU 30 or various kinds of data, and the storage unit 32 includes, for example, a non-volatile memory, a volatile memory, or a magnetic disk.

The CPU 30 includes a preparation-processing unit 33, a request unit 34, and a determination unit 35 that serve as functional processing units that are provided by reading and running the computer program that is stored in the storage unit 32 by the CPU 30.

The preparation-processing unit 33 receives the reservation information from the terminal device 1 via the communication unit 31 and provides the received reservation information to the request unit 34. The preparation-processing unit 33 executes an instruction for preparing the provision target such that the provision target can be provided at the estimated time of arrival that is represented by the reservation information. For example, in the case where the provision target is food such as a hamburger or a drink, the preparation-processing unit 33 transmits information about the instruction for preparation including the provision target and the estimated time of arrival to a terminal device that is used by a provider who provides the food. In the case where the provision target is a manipulation such as a massage, the preparation-processing unit 33 transmits the information about the instruction for preparation including the provision target and the estimated time of arrival to a terminal device that is used by a manipulator.

The request unit 34 makes a request for delivery of the provision target to the charging station or transportation to the location at which the provision target is provided, based on the reservation information that is acquired from the preparation-processing unit 33. For example, in the case where it is necessary to deliver the provision target such as the case where food that is cooked at a cooking location is delivered to the charging station, the request unit 34 requests the delivery server 4 to deliver the provision target. In the case where a facility in which a massage is given is away from the charging station, and it is necessary to transport the user from the charging station to the facility, the request unit 34 requests the delivery server 4 to transport the user from the charging station.

The determination unit 35 receives the reservation change information from the terminal device 1 via the communication unit 31 and determines whether the reservation for the provision target that is represented by the received reservation change information can be changed or the reservation can be cancelled. For example, in the case where the reservation change information represents a time at which the provision target is provided is delayed, the determination unit 35 determines the reservation can be changed if a time from the current time to the original time is equal to or more than a predetermined time (for example, 30 minutes) and determines the reservation cannot be cancelled if the time is less than the predetermined time. In the case where the reservation change information represents cancellation of the provision target and a reserved provision time (the estimated time of arrival), the determination unit 35 determines the reservation can be cancelled if a time from the current time to the provision time is equal to or more than a predetermined time (for example, 30 minutes) and determines the reservation cannot be cancelled if the time is less than the predetermined time. Consequently, the change in the reservation and the cancellation thereof with time to spare are permitted, but neither sudden change in the reservation nor sudden cancelation thereof is permitted.

In the case where the reservation can be changed or cancelled, the determination unit 35 transmits the changeable information that represents the content of the change in the reservation or the content of the cancellation thereof to the terminal device 1 and the path-finding server 2 via the communication unit 31. The determination unit 35 executes a provision target change instruction that represents an instruction for changing or canceling the reservation. For example, the determination unit 35 transmits information that represents the content of the change in the reservation or the cancellation thereof to a terminal device that is used by a provider who provides the product or service. In the case where it is necessary to deliver the provision target or to transport the user, the determination unit 35 requests the delivery server 4 to change delivery or transportation.

In the case where the reservation cannot be changed or cancelled, the determination unit 35 transmits unchangeable information that represents this content to the terminal device 1 via the communication unit 31.

### <Structure of Delivery Server>

FIG. 9 is a block diagram illustrating the structure of the delivery server 4.

The delivery server 4 includes a CPU 40, a communication unit 41, and a storage unit 42.

The communication unit 41 includes a wireless communication interface or a wired communication interface for connecting the delivery server 4 to the network 6.

The storage unit 42 is a storage device for storing a computer program that is performed by the CPU 40 or various kinds of data, and the storage unit 42 includes, for example, a non-volatile memory, a volatile memory, or a magnetic disk.

The CPU 40 includes a delivery-transport-processing unit 43 that serves as a functional processing unit that is provided by reading and running the computer program that is stored in the storage unit 42 by the CPU 40.

The delivery-transport-processing unit 43 receives the request for delivery or transportation from the provision server 3 via the communication unit 41. The delivery-transport-processing unit 43 responds to the request and requests the delivery service to deliver the provision target or requests a transportation service to transport the user at the charging station.

The delivery-transport-processing unit 43 receives a request for changing delivery or transportation from the provision server 3 via the communication unit 41. The delivery-transport-processing unit 43 responds to the request and requests the delivery service to change the delivery or requests the transportation service to change the transportation.

### <Procedures for Processing of Terminal Device>

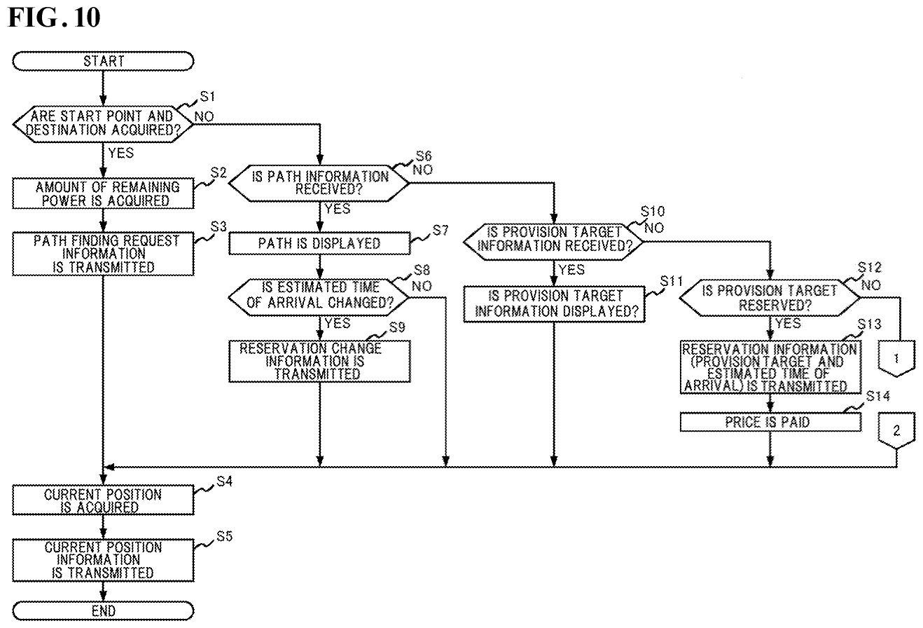

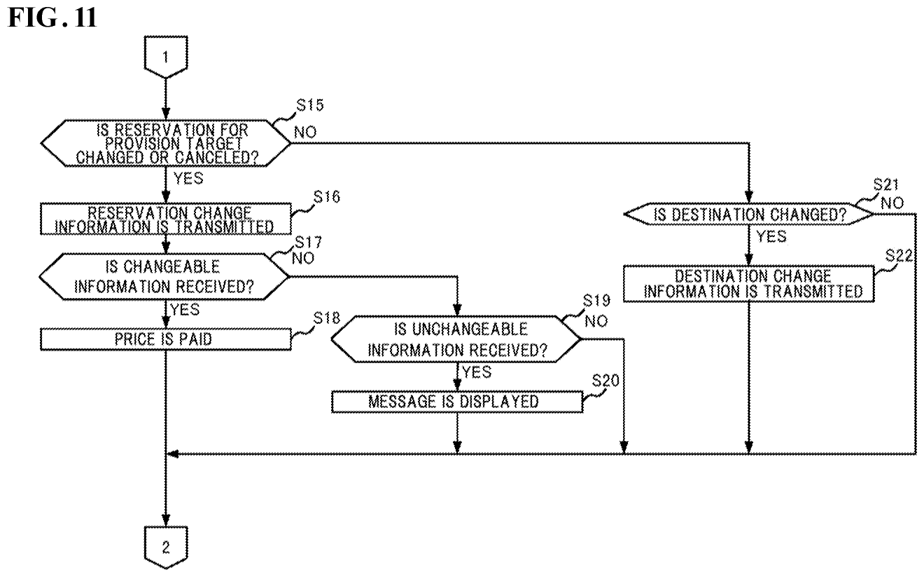

FIG. 10 and FIG. 11 are flowcharts illustrating procedures for processing that is performed by the terminal device 1.

Referring to FIG. 10, if the request unit 13 acquires the information about the start point and destination of the vehicle 5 by a user input (YES at S1), the request unit 13 acquires the amount of remaining power of the drive battery that is mounted in the vehicle 5 (S2).

The request unit 13 transmits the path finding request information including the information about the start point, the destination, and the amount of remaining charge to the path-finding server 2 (S3).

Subsequently, the request unit 13 acquires the current position of the vehicle 5 from the GPS receiver (S4).

The request unit 13 transmits the current position information that represents the acquired current position to the path-finding server 2 (S5).

If the path-information-acquiring unit 14 acquires the path information about the path that extends from the start point or the current position to the destination from the path-finding server 2 (NO at S1, YES at S6), the display control unit 16 causes the path information that is acquired by the path-information-acquiring unit 14 to be displayed on the screen of the display device (S7).

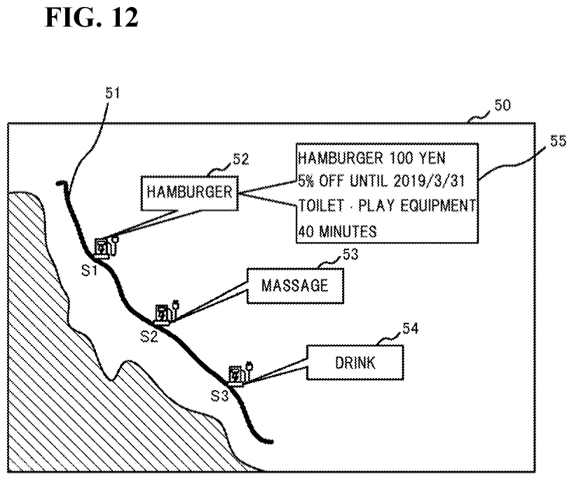

FIG. 12 illustrates an example of the path information that is displayed on the screen.

For example, the display control unit 16 causes a map 50 to be displayed on the screen of the display device and causes a path 51 that extends from the start point to the destination to be displayed by a thick line on the map 50. The display control unit 16 causes the icons of the charging stations S1 to S3 to be displayed as the candidates for the waypoint on the path.

Referring to FIG. 10 again, in the case where the provision target at the waypoint has been reserved, and it is determined that the estimated time of arrival at the waypoint is changed based on the received path information (YES at S8), the reservation-processing unit 17 transmits the reservation change information including the changed estimated time of arrival to the provision server 3 (S9). Subsequently, the processing proceeds to a step S4.

If the estimated time of arrival is not changed (NO at S8), the processing proceeds to the step S4.

If the provision-target-information-acquiring unit 15 acquires the provision target information that represents the provision target that is providable at the waypoint from the path-finding server 2 (NO at S6, YES at S10), the display control unit 16 causes the acquired provision target information to be displayed on the screen of the display device (S11). For example, as illustrated in FIG. 12, the provision-target-information-acquiring unit 15 causes provision target information 52 to 54 that is providable at the charging stations 51 to S3 each of which is the waypoint to be displayed. The provision target information 52 represents that a hamburger is providable at the charging station 51. The provision target information 53 represents that a massage is providable at the charging station S2. The provision target information 54 represents that a drink is providable at the charging station S3. The detailed information of the provision target information can be displayed on the screen. For example, in the case where the user selects the provision target information 52 by a tap operation, detailed provision target information 55 is displayed. The provision target information 55 includes equipment information and related information of the facility information 22b illustrated in FIG. 5. Subsequently, the processing proceeds to the step S4.

Referring to FIG. 10 again, if the user selects the provision target, for example, by tapping the provision target information that is displayed on the screen, and the user reserves the provision target (NO at S10, YES at S12), the reservation-processing unit 17 transmits the reservation information for reserving the provision target to the path-finding server 2 and the provision server 3 (S13). The reservation information includes information about, for example, the provision target, the number of the provision target, and the estimated time of arrival at the waypoint.

The payment-processing unit 18 performs a process of paying the price of the provision target (S14). Subsequently, the processing proceeds to the step S4.

Referring to FIG. 11, if the user makes a request for changing or cancelling the reservation for the provision target (NO at S12 in FIG. 10, YES at S15 in FIG. 11), the reservation-processing unit 17 transmits the reservation change information for changing or cancelling the reservation to the provision server 3 (S16). The reservation change information includes information about, for example, the provision target that is to be changed or cancelled, the number of the provision target, and the changed time.

If the communication unit 11 receives the changeable information that represents that the reservation can be changed (YES at S17), the payment-processing unit 18 performs the process of paying the price (S18). Subsequently, the processing proceeds to the step S4. The payment process (S18) is performed only when the content of the provision target or the number of the provision target is changed.

If the communication unit 11 receives the unchangeable information that represents that the reservation cannot be changed (NO at S17, YES at S19), the display control unit 16 causes a message that represents that the reservation cannot be changed to be displayed on the screen (S20). Subsequently, the processing proceeds to the step S4.

If the unchangeable information is not received (NO9 at S19), the processing proceeds to the step S4.

If the destination is changed by a user input (NO at S15, YES at S21), the request unit 13 transmits destination change information that represents the changed destination to the path-finding server 2 (S22). Subsequently, the processing proceeds to the step S4.

If the destination is not changed (NO at S21), the processing proceeds to the step S4.

The terminal device 1 repeatedly performs the processes illustrated in FIG. 10 and FIG. 11.

### <Procedures for Processing of Path-finding Server>

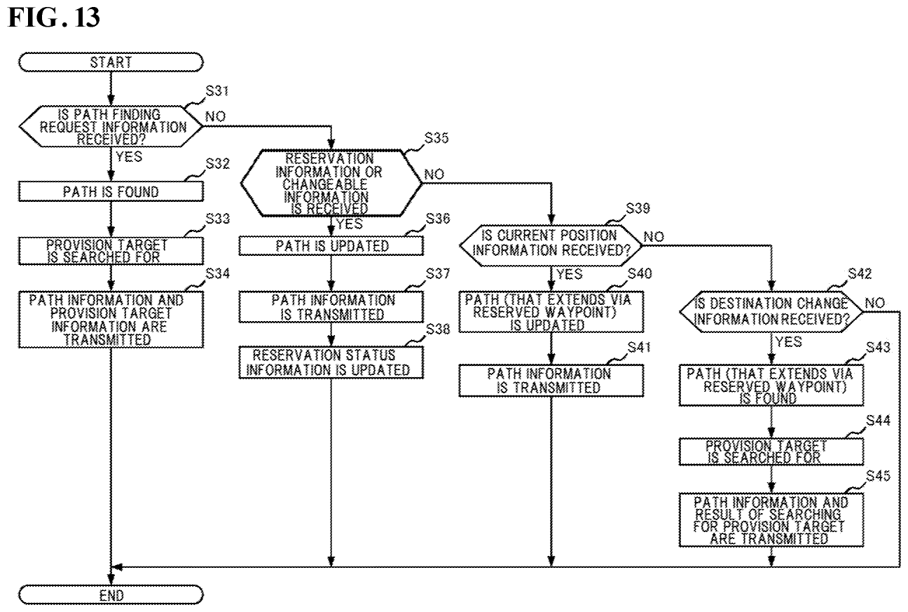

FIG. 13 is a flowchart illustrating procedures for processing that is performed by the path-finding server 2.

Referring to FIG. 13, if the path-finding unit 23 receives the path finding request information from the terminal device 1 (YES at S31), the path-finding unit 23 finds the movement path that extends from the start point to the destination via the waypoint that is the charging station, based on the received path finding request information such that the amount of remaining charge of the drive battery that is mounted in the vehicle 5 does not become less than the predetermined power threshold when the vehicle 5 moves from the start point that is represented by the path finding request information to the destination (S32).

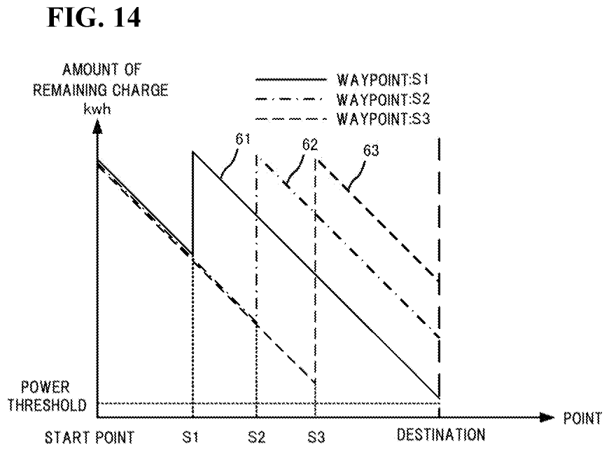

FIG. 14 illustrates an example of transition of the amount of remaining charge of the vehicle 5 that travels along the movement path. The horizontal axis represents points from the start point to the destination. The vertical axis represents the amount of remaining charge. The illustration contains, when the charging stations S1, S2, and S3 are located between the start point and the destination, the amount of remaining charge 61 in the case where the vehicle is charged at the charging station S1, the amount of remaining charge 62 in the case where the vehicle is charged at the charging station S2, and the amount of remaining charge 63 in the case where the vehicle is charged at the charging station S3. As seen from FIG. 14, the path-finding unit 23 finds the movement path for charging at each charging station and for movement to the destination under a constraint that the amount of remaining charge does not become less than the predetermined power threshold. The amounts of remaining charge upon arrival at charging stations are in descending order of the charging stations S1, S2, and S3. Thus, the charging times at the respective charging stations are in ascending order of the charging stations S1, S2, and S3.

Referring to FIG. 13 again, the search unit 24 searches for the provision target that is providable at the waypoint that is found by the path-finding unit 23, based on the facility information 22b (S33).

The path-finding unit 23 transmits the path information including the found movement path and the charging time at the waypoint to the terminal device 1. The search unit 24 transmits the provision target information that represents the searched provision target to the terminal device 1 (S34).

If the update unit 25 receives the reservation information about the provision target from the terminal device 1 or receives the changeable information about the provision target from the provision server 3 (NO at S31, YES at S35), the path-finding unit 23 performs a process of updating the movement path, based on the reservation information or the changeable information (S36). For example, in the case where the user newly reserves the provision target that is provided at the charging station S1, the path-finding unit 23 finds a movement path that extends via the waypoint that is the charging station S1. In the case where the user cancels the provision target that is provided at the charging station S1, the path-finding unit 23 excludes the charging station S1 from the waypoint and finds the movement path again. However, in some cases where the amount of remaining charge of the vehicle 5 becomes less than the power threshold if the vehicle is not charged at the charging station S1, the movement path that extends via the waypoint that is the charging station S1 is found.

The path-finding unit 23 transmits the path information including the found movement path to the terminal device 1 (S37).

The update unit 25 updates the reservation status information 22c that is stored in the storage unit 22 (S38). For example, the update unit 25 adds, to the reservation status information 22c, the charging station and the estimated time of arrival at the charging station that are represented by the received reservation information and the vehicle ID of the vehicle 5 in which the terminal device 1 that transmits the reservation information is mounted. In the case where the received changeable information represents that the provision target is cancelled, the update unit 25 deletes a record that contains the vehicle ID and the charging station that are represented by the changeable information from the reservation status information 22c. In the case where the changeable information represents that the estimated time of arrival is changed, the update unit 25 updates the reservation status information 22c, based on the vehicle ID, the charging station, and the changed estimated time of arrival that are represented by the changeable information.

If the path-finding unit 23 receives the current position information about the vehicle 5 from the terminal device 1 (NO at S35, YES at S39), the path-finding unit 23 updates the movement path, based on the current position information (S40). That is, the path-finding unit 23 finds a path that extends from the current position that is represented by the current position information to destination via the waypoint that is registered in the reservation status information 22c.

The path-finding unit 23 transmits the path information that represents the found movement path to the terminal device 1 (S41).

If the path-finding unit 23 receives the destination change information from the terminal device 1 (NO at S39, YES at S42), the path-finding unit 23 finds a movement path that extends to the changed destination, based on the destination change information (S43). That is, the path-finding unit 23 finds the path that extends to the changed destination via the waypoint that is registered in the reservation status information 22c.

The search unit 24 searches for the provision target that is providable at the waypoint that is found by the path-finding unit 23, based on the facility information 22b (S43).

The path-finding unit 23 transmits the path information including the found movement path and the charging time at the waypoint to the terminal device 1, and the search unit 24 transmits the provision target information that represents the searched provision target to the terminal device 1 (S45).

The path-finding server 2 repeatedly performs the processes illustrated in FIG. 13.

### <Procedures for Processing of Path-finding Server>

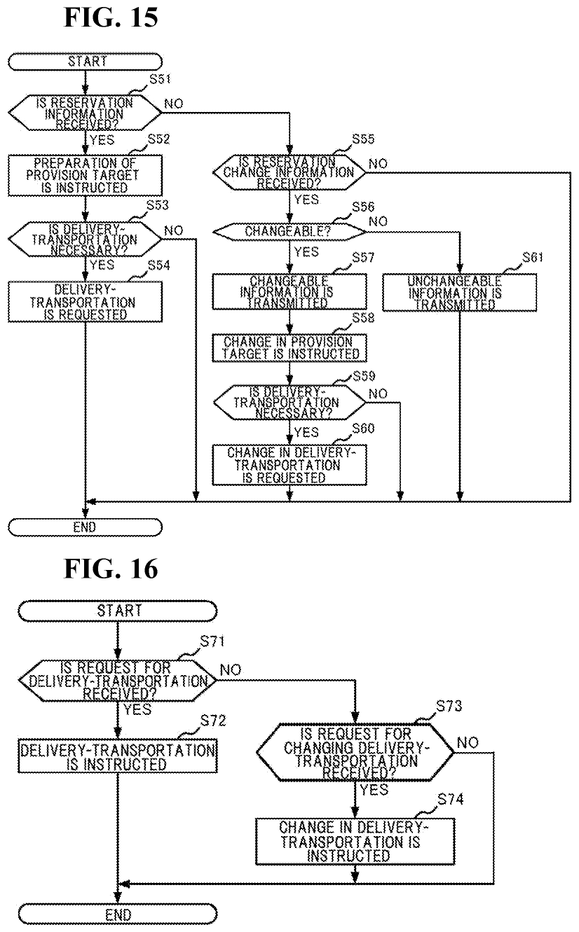

FIG. 15 is a flowchart illustrating procedures for processing that is performed by the provision server 3.

Referring to FIG. 15, if the preparation-processing unit 33 receives the reservation information from the terminal device 1 (YES at S51), the preparation-processing unit 33 executes an instruction for preparing the provision target such that the provision target can be provided at the estimated time of arrival that is represented by the reservation information (S52).

The request unit 34 determines whether it is necessary to deliver the provision target or to transport the user, based on the reservation information (S53). If delivery or transportation is necessary, the request unit 34 requests the delivery server 4 to deliver the provision target to the charging station or to transport the user to the location at which the provision target is provided (S54).

If the determination unit 35 receives the reservation change information from the terminal device 1 (NO at S51, YES at S55), the determination unit 35 determines whether the reservation can be changed or cancelled (S56).

If the reservation can be changed or cancelled (YES at S56), the determination unit 35 transmits the changeable information to the terminal device 1 and the path-finding server 2 (S57).

The determination unit 35 executes the provision target change instruction that represents the instruction for changing or canceling the reservation, based on the reservation change information (S58).

If it is necessary to deliver the provision target or to transport the user (YES at S59), the determination unit 35 requests the delivery server 4 to change delivery or transportation (S60).

If the reservation cannot be changed or cancelled (NO at S56), the determination unit 35 transmits the unchangeable information to the terminal device 1 (S61).

The provision server 3 repeatedly performs the processes illustrated in FIG. 15.

### <Procedures for Processing of Delivery Server>

FIG. 16 is a flowchart illustrating procedures for processing that is performed by the delivery server 4.

Referring to FIG. 16, if the delivery-transport-processing unit 43 receives the request for delivery or transportation from the provision server 3 (YES at S71), the delivery-transport-processing unit 43 requests the delivery service to deliver the provision target to the charging station or requests the transportation service to transport the user at the charging station (S72).

If the delivery-transport-processing unit 43 receives the request for changing the delivery or the transportation from the provision server 3 (NO at S71, YES at S73), the delivery-transport-processing unit 43 requests the delivery service to change the delivery or requests the transportation service to change the transportation (S74).

The delivery server 4 repeatedly performs the processes illustrated in FIG. 16.

### <Process Sequence of Provision-Target-Searching System (Part 1)>

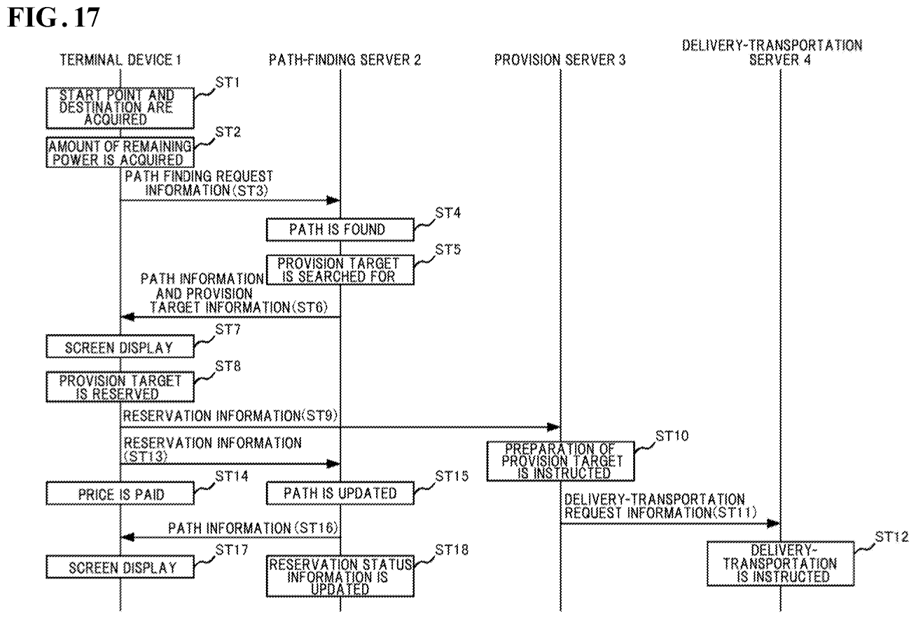

FIG. 17 illustrates an example of the process sequence of the provision-target-searching system 100.

The terminal device 1 acquires the start point and destination of the vehicle 5 (ST1).

The terminal device 1 also acquires the amount of remaining power of the vehicle 5 (ST2).

The terminal device 1 transmits the path finding request information that represents the start point, destination, and amount of remaining power of the vehicle 5 to the path-finding server 2, and the path-finding server 2 receives the path finding request information (ST3).

The path-finding server 2 finds the movement path that extends from the start point to the destination and the waypoint, based on the received path finding request information (ST4).

The path-finding server 2 searches for the provision target that is providable at the found waypoint (ST5).

The path-finding server 2 transmits the path information that represents the found movement path and waypoint and the provision target information that represents the provision target that is providable at the waypoint to the terminal device 1, and the terminal device 1 receives the path information and the provision target information (ST6).

The terminal device 1 displays the path information and the provision target information that are received on the screen of the display device (ST7). For example, this results in screen display illustrated in FIG. 12.

The terminal device 1 accepts the reservation for the provision target by a user input (ST8).

The terminal device 1 transmits the reservation information about the provision target to the provision server 3, and the provision server 3 receives the reservation information (ST9).

The provision server 3 instructs the provider who provides the provision target to prepare the provision target, based on the reservation information (ST10).

The provision server 3 transmits delivery-transportation request information for the request for the necessary delivery or transportation to provide the provision target to the delivery server 4, based on the reservation information, and the delivery server 4 receives the delivery-transportation request information (ST11).

The delivery server 4 instructs the delivery service or the transportation service to deliver the provision target or to transport the user, based on the delivery-transportation request information (ST12).

The terminal device 1 transmits the reservation information about the provision target to the path-finding server 2, and the path-finding server 2 receives the reservation information (ST13).

The terminal device 1 performs the process of paying the price of the reserved provision target (ST14).

The path-finding server 2 performs the process of updating the movement path, based on the received reservation information (ST15).

The path-finding server 2 transmits the path information that represents the updated movement path to the terminal device 1, and the terminal device 1 receives the path information (ST16).

The terminal device 1 displays the received path information on the screen of the display device (ST17).

The path-finding server 2 updates the reservation status information 22c, based on the received reservation information (ST18).

### <Process Sequence of Provision-Target-Searching System (Part 2)>

In an example of the process sequence described below, the estimated time of arrival at the waypoint at which the provision target is provided is changed after the vehicle 5 starts traveling.

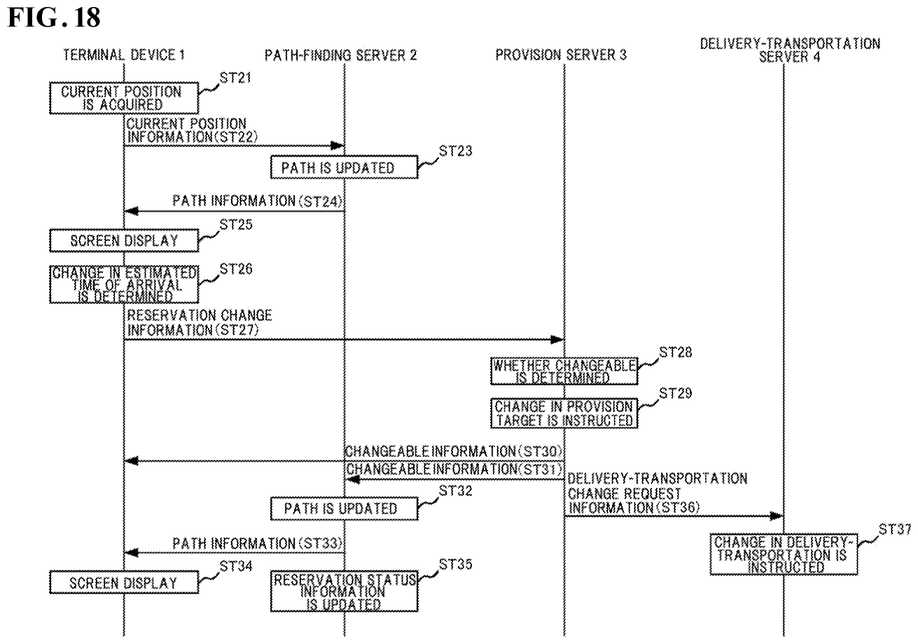

FIG. 18 illustrates an example of the process sequence of the provision-target-searching system 100.

Referring to FIG. 18, the terminal device 1 acquires the current position of the vehicle 5 (ST21).

The terminal device 1 transmits the acquired current position information about the vehicle 5 to the path-finding server 2, and the path-finding server 2 receives the current position information (ST22).

The path-finding server 2 updates the movement path of the vehicle 5, based on the received current position information (ST23).

The path-finding server 2 transmits the path information that represents the updated movement path to the terminal device 1, and the terminal device 1 receives the path information (ST24).

The terminal device 1 displays the received path information on the screen of the display device (ST25).

The terminal device 1 determines that the estimated time of arrival at the waypoint for the reservation for the provision target is changed from the original estimated time of arrival, based on the received path information (ST26). A slight change in the estimated time of arrival may be permitted. For example, in the case where the estimated time of arrival is delayed 5 minutes or more, the terminal device 1 may determine that the estimated time of arrival is changed.

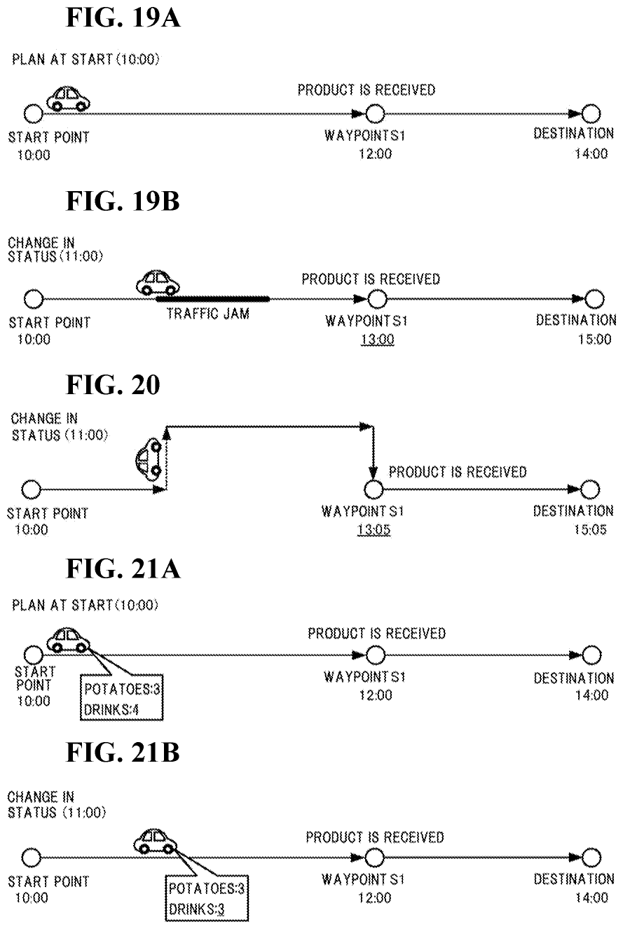

In the following description with reference to FIG. 19A and FIG. 19B, it is determined that the estimated time of arrival is changed. FIG. 19A illustrates an example of the movement path of the vehicle 5 when the provision target is reserved. That is, FIG. 19A illustrates the movement path on which the vehicle 5 starts at the start point at 10:00, is charged at the charging station S1 at 12:00, receives a product, and arrives at the destination at 14:00. FIG. 19B illustrates an example of the movement path of the vehicle 5 after the vehicle starts at the start point. That is, FIG. 19B illustrates the movement path on which the vehicle 5 is stuck in a traffic jam at 11:00 between the start point and the charging station S1, is charged at the charging station S1 at 13:00, receives the product, and arrives at the destination at 15:00. In this case, the estimated time of arrival at the charging station S1 is changed from 12:00 into 13:00, and the terminal device 1 determines that the estimated time of arrival at the charging station S1 for the reservation for the provision target is changed.

Referring to FIG. 18 again, the terminal device 1 transmits the reservation change information for notification of the changed estimated time of arrival to the provision server 3, and the provision server 3 receives the reservation change information (ST27).

The provision server 3 determines whether the reservation can be changed, based on the received reservation change information and determines that the reservation can be changed (ST28). That is, the provision server 3 determines that the reservation can be changed because a time from the current time, 11:00, to the original estimated time of arrival at the charging station S1, 12:00, is equal to or more than the predetermined time (for example, 30 minutes).

The provision server 3 transmits a provision target change instruction for notification of the changed estimated time of arrival to the terminal device that is used by the provider who provides the product or service and changes the reservation for the provision target (ST29).

The provision server 3 transmits the changeable information that represents that the reservation can be changed to the terminal device 1, and the terminal device 1 receives the changeable information (ST30).

The provision server 3 transmits the changeable information that represents that the reservation can be changed to the path-finding server 2, and the path-finding server 2 receives the changeable information (ST31).

The path-finding server 2 updates the movement path of the vehicle 5 that extends through the charging station S1, based on the changeable information (ST32). That is, the path-finding server 2 finds the movement path that extends through the charging station S1 where the change in the estimated time of arrival is permitted.

The path-finding server 2 transmits the path information that represents the movement path to the terminal device 1, and the terminal device 1 receives the path information (S33).

The terminal device 1 displays the received path information on the screen of the display device (S34).

The path-finding server 2 updates the estimated time of arrival in the reservation status information 22c, based on the received changeable information (ST35).

The provision server 3 determines that it is necessary to change the delivery or the transportation due to the change in the estimated time at which the vehicle 5 arrives. The provision server 3 transmits delivery-transportation change request information including the changed estimated time of arrival to the delivery server 4, and the delivery server 4 receives the delivery-transportation change request information (ST36).

The delivery server 4 transmits a delivery-transportation change instruction for notification of the changed estimated time of arrival to a terminal device that is used by the delivery service or the transportation service for instruction for changing the delivery or the transportation (ST37).

### <Process Sequence of Provision-Target-Searching System (Part 3)>

In an example of the process sequence described below, the vehicle 5 deviates from the movement path and travels after the vehicle 5 starts traveling.

For example, suppose that the same movement path as in FIG. 19A is calculated when the provision target is reserved. Subsequently, the vehicle 5 deviates from the movement path and travels. FIG. 20 illustrates an example of the movement path of the vehicle 5 after the vehicle starts at the start point. That is, FIG. 20 illustrates the movement path on which the vehicle 5 starts deviating from the movement path and travelling after the vehicle 5 starts at the start point and before the vehicle 5 arrives at the charging station S1, is charged at the charging station S1 at 13:05, receives the product, and arrives at the destination at 15:05.

In this case, the process sequence of the provision-target-searching system is the same as in FIG. 18.

In a path update process (ST23 and ST32), the path-finding server 2 refers to the reservation status information 22c and updates the movement path such that the movement path extends via the charging station that is registered as the waypoint of the vehicle 5. For example, the reservation status information 22c represents that the vehicle 5 having the vehicle ID “C1” moves via the charging station S1 at 12:00, and the path-finding server 2 accordingly updates the movement path such that the movement path extends via the charging station S1.

### <Process Sequence of Provision-Target-Searching System (Part 4)>

In an example of the process sequence described below, the product that is reserved is received at the waypoint is changed after the vehicle 5 starts travelling.

FIG. 21A illustrates an example of a plan for a product reservation and the movement path at the start. As illustrated in FIG. 21A, the plan is such that the vehicle 5 starts at the start point at 10:00, is charged at the charging station S1 at 12:00, receives three potatoes and four drinks, and arrives at the destination at 14:00. FIG. 21B illustrates an example of a change in the product reservation. For example, suppose that the number of the reserved drinks is changed from 4 to 3 in a period from the start at the start point to arrival at the charging station S1. A time of change is 11:00 and is 1 hour prior to the estimated time of arrival at the charging station S1, 12:00.

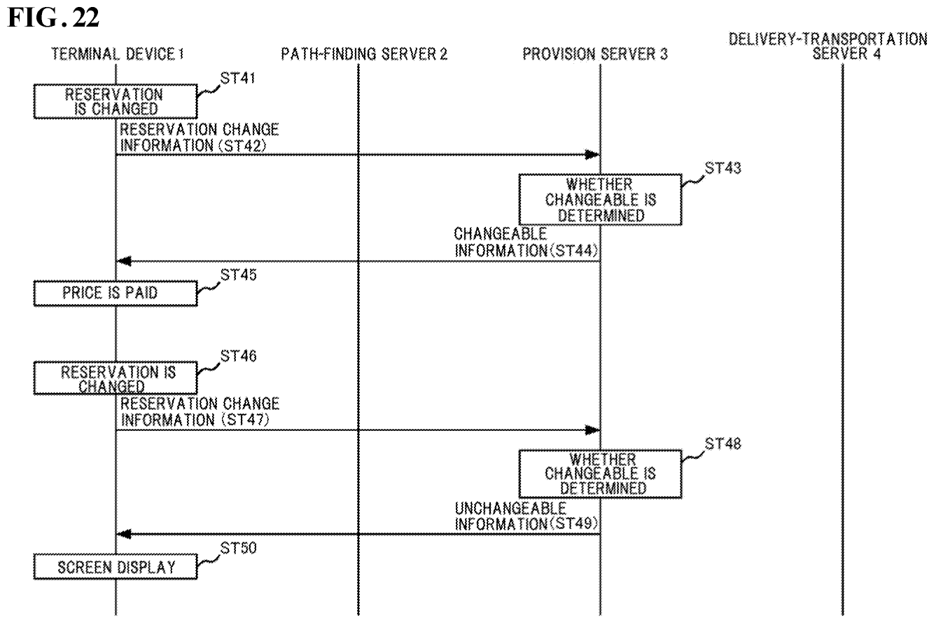

FIG. 22 illustrates an example of the process sequence of the provision-target-searching system 100.

The terminal device 1 accepts the input of the change in the reservation from the user (ST41).

The terminal device 1 transmits the reservation change information that represents the content of the change in the product to the provision server 3, and the provision server 3 receives the reservation change information (ST42).

The provision server 3 determines whether the reservation can be changed, based on the reservation change information and determines that the reservation can be changed (ST43). That is, the provision server 3 determines that the reservation can be changed because a time from the current time, 11:00, to the estimated time of arrival at the charging station S1, 12:00, is equal to or more than the predetermined time (for example, 30 minutes).

The provision server 3 transmits the changeable information that represents that the reservation can be changed to the terminal device 1, and the terminal device 1 receives the changeable information (ST44).

Subsequently, the terminal device 1 makes payment of the price of the changed provision target (ST45). Here, a refund process for the price of a single drink is performed.

Subsequently, the terminal device 1 accepts the input of the change in the reservation again from the user (ST46). For example, suppose that the input of the cancellation of the reservation for the provision target is accepted at 11:50 that is 10 minutes prior to the estimated time of arrival at the charging station S1.

The terminal device 1 transmits the reservation change information that represents that the reservation for the provision target is cancelled to the provision server 3, and the provision server 3 receives the reservation change information (ST47).

The provision server 3 determines whether the reservation can be changed, based on the reservation change information and determines that the reservation cannot be changed (ST48). That is, the provision server 3 determines that the reservation cannot be changed because a time from the current time to the estimated time of arrival is 10 minutes and is less than the predetermined time (for example, 30 minutes).

The provision server 3 transmits the unchangeable information that represents that the reservation cannot be changed to the terminal device 1, and the terminal device 1 receives the unchangeable information (ST49).

The terminal device 1 displays a message that represents the reservation cannot be changed on the screen of the display device (ST50).

### <Process Sequence of Provision-Target-Searching System (Part 5)>

In an example of the process sequence described below, the destination is changed after the vehicle 5 starts traveling.

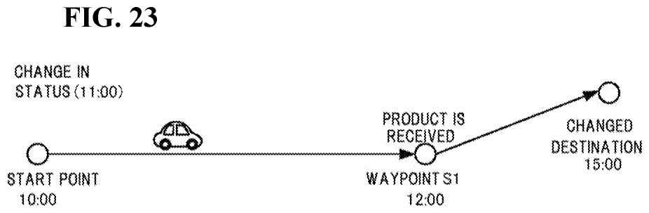

For example, suppose that the same movement path as in FIG. 19A is calculated when the provision target is reserved. Suppose that the destination of the vehicle 5 is subsequently changed. FIG. 23 illustrates an example of the movement path of the vehicle 5 after the vehicle starts at the start point. That is, FIG. 23 illustrates the movement path in the case where the destination is changed at 11:00 after the vehicle 5 starts at the start point and before the vehicle 5 arrives at the charging station S1.

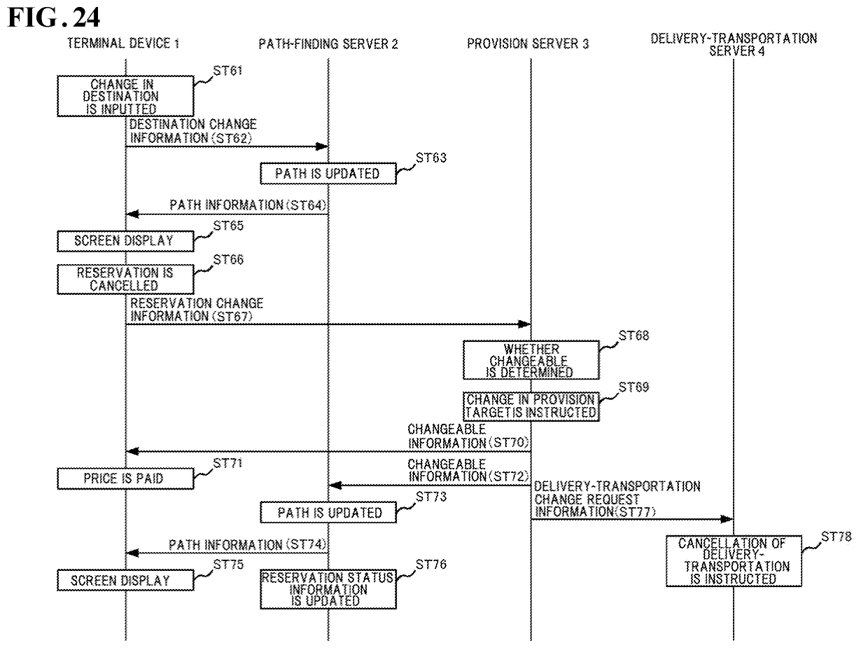

FIG. 24 illustrates an example of the process sequence of the provision-target-searching system 100.

Referring to FIG. 24, the terminal device 1 accepts the input of the change in the destination from the user (S61).

The terminal device 1 transmits the destination change information that represents the changed destination to the path-finding server 2, and the path-finding server 2 receives the destination change information (ST62).

The path-finding server 2 refers to the reservation status information 22c and finds a movement path that extends to the destination that is represented by the destination change information (ST63). That is, the path-finding server 2 finds the movement path that reaches the changed destination via the waypoint that is the charging station S1 that is registered in the reservation status information 22c.

The path-finding server 2 transmits the path information that represents the found movement path to the terminal device 1, and the terminal device 1 receives the path information (ST64).

The path-finding server 2 displays the received path information on the screen of the display device (ST65).

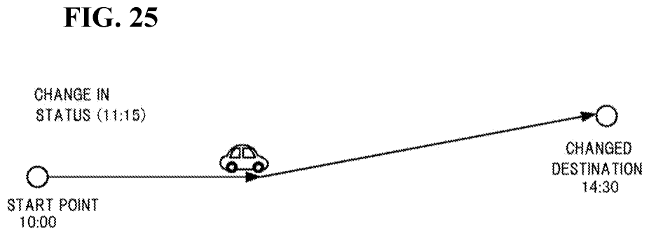

Suppose that the terminal device 1 cancels the reservation for the product as follows. FIG. 25 illustrates an example of the movement path of the vehicle 5 after the reservation for the product is cancelled. As illustrated in FIG. 25, suppose that the user cancels the reservation for the product at 11:15.

Referring to FIG. 24 again, suppose that the terminal device 1 accepts the input of the cancellation of the reservation for the provision target (ST66).

The terminal device 1 transmits the reservation change information that represents that the reservation for the provision target is cancelled to the provision server 3, and the provision server 3 receives the reservation change information (ST67).

The provision server 3 determines whether the reservation can be changed, based on the received reservation change information and determines that the reservation can be changed (ST68). That is, the provision server 3 determines that the reservation can be changed because a time from a time at which the reservation is cancelled, 11:15, to the estimated time of arrival at the charging station S1 is equal to or more than the predetermined time (for example, 30 minutes).

The provision server 3 transmits the provision target change instruction that represents the reservation for the provision target is cancelled to the terminal device that is used by the provider who provides the product or service, and cancels and changes the reservation for the provision target (ST69).

The provision server 3 transmits the changeable information that represents that the reservation can be changed to the terminal device 1, and the terminal device 1 receives the changeable information (ST70).

The terminal device 1 performs the process of paying a refund for the price of the provision target the reservation for which is cancelled (ST71).

The provision server 3 transmits the changeable information that represents that the reservation can be changed to the path-finding server 2, and the path-finding server 2 receives the changeable information (ST72). The changeable information includes information about the waypoint at which the provision target, the reservation for which is cancelled, is originally planned to be provided.

The path-finding server 2 updates the movement path of the vehicle 5, based on the changeable information (ST73). That is, the path-finding server 2 finds a movement path that does not extend through the charging station S1 at which the provision target is originally planned to be provided and that reaches the changed destination.

The path-finding server 2 transmits the path information that represents the movement path to the terminal device 1, and the terminal device 1 receives the path information (S74).

The terminal device 1 displays the received path information on the screen of the display device (S75).

The path-finding server 2 deletes the information about the waypoint at which the provision target, the reservation for which is cancelled, is originally planned to be provided from the reservation status information 22c, based on the received changeable information (ST76).

The provision server 3 determines that it is necessary to cancel the delivery or the transport due to the cancellation of the reservation. The provision server 3 transmits the delivery-transportation change request information for a request for cancelling the delivery or the transport to the delivery server 4, and the delivery server 4 receives the delivery-transportation change request information (ST77).

The delivery server 4 transmits the delivery-transportation change instruction for notification of the cancellation of the delivery or the transport to the terminal device that is used by the delivery service or the transportation service for instruction for cancelling the delivery or the transport (ST78).

### Effects of Embodiments

According to the embodiments of the present disclosure, the path that extends via the waypoint that is the charging facility is found, and search for the provision target that is providable to the user can be carried out during charging of the vehicle 5 as described above. Thus, the planning of the appropriate path and charging and the effective use of the charging time can be achieved at the same time.

The path-finding server 2 finds the path for charging at the waypoint under the constraint that the amount of remaining power of the vehicle 5 does not become less than the predetermined power threshold. Thus, the vehicle can be prevented from being unable to travel because the amount of remaining power decreases while the vehicle travels halfway.

The path-finding server 2 selects the provision target at the waypoint, based on the advertising cost of the provision target and provides this to the terminal device 1. Thus, the user can readily select the provision target.

When the user reserves the provision target, the terminal device 1 notifies the provision server 3 of the reserved provision target and the estimated time of arrival at the charging facility at which the provision target is providable. Thus, the provider who provides the provision target can prepare the provision target in good time for the estimated time at which the user arrivals.

The path-finding server 2 finds the path that extends from the current position to the destination via the waypoint that is the charging facility at which the provision target that is reserved by the user is providable, based on the current position of the vehicle 5. Thus, the reserved provision target can be provided to the user, for example, even in the case where the vehicle 5 deviates from the path.

In the case where the estimated time of arrival is changed, the path-finding server 2 notifies the provision server 3 of the changed estimated time of arrival. Thus, the provider who provides the provision target can prepare the provision target in good time for the latest estimated time of arrival.

In the case where the provision target is changed, the path-finding server 2 notifies the provision server 3 of the changed provision target. Thus, in the case where the provision target is changed, the provider who provides the provision target can make preparation corresponding to the change.

In the case where the destination is changed, the path-finding server 2 again finds the path that extends to the changed destination via the waypoint that is the charging facility at which the provision target is providable. Thus, even in the case where the destination is changed, the reserved provision target can be provided to the user.

### Modification

According to the embodiments described above, as illustrated in FIG. 7, the search unit 24 of the path-finding server 2 selects the provision target, the advertising cost of which is highest, for each charging station from the facility information 22b. However, a method of selecting the provision target is not limited thereto.

In an example described according to the present modification, the provision target is selected based on the consumption time that is consumed to provide the provision target and the charging time.

For example, suppose that the charging times at the charging stations S1, S2, and S3 that are calculated by the path-finding unit 23 of the path-finding server 2 are 20 minutes, 40 minutes, and 60 minutes, respectively.

The search unit 24 searches for the single provision target closest to the charging time for each charging station, based on the facility information 22b illustrated in FIG. 5.

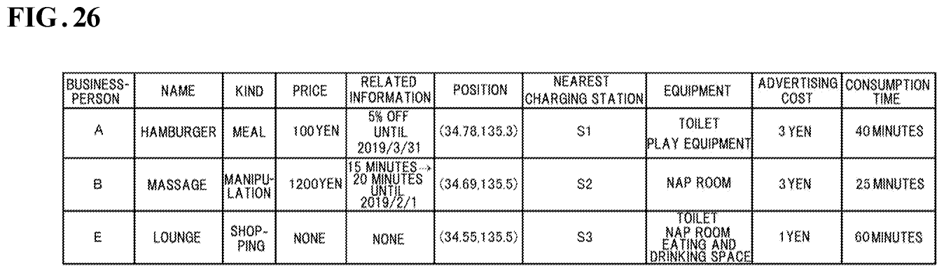

FIG. 26 illustrates examples of the provision target for which the search unit 24 searches. The search unit 24 selects the provision targets the nearest charging stations of which are S1, S2, and S3 from the facility information 22b illustrated in FIG. 5. Consequently, the provision targets of the businesspeople A to E are selected. Subsequently, the search unit 24 selects the provision target of the businessperson A that has a consumption time of 40 minutes closest to a charging time of 20 minutes from the provision target that is providable at the charging station S1. The search unit 24 selects the provision target of the businessperson B that has a consumption time of 25 minutes closest to a charging time of 40 minutes from the provision target that is providable at the charging station S2. The search unit 24 selects the provision target of the businessperson E that has a consumption time of 60 minutes closest to a charging time of 60 minutes from the provision targets that are providable at the charging station S3.

According to the present modification, the provision target that has a consumption time suitable for the charging time can be provided to the user. For example, the user can effectively use the charging time by being provided with the provision target that has the consumption time closest to the charging time.

### [Additional Remarks]

One or all of the elements that are included in each apparatus or device described above may be a semiconductor device or semiconductor devices such as system LSI.

The computer programs described above may be stored in a non-transitory computer-readable storage medium such as a HDD, a CD-ROM, and a semiconductor memory and distributed. The computer programs may be transmitted and distributed via, for example, telecommunication, a wireless or wired communication line, a network representative of the Internet, or data broadcasting.

Multiple computers may serve as each apparatus or device.

One or all of the functions of each apparatus or device described above may be provided by cloud computing. That is, one or all of the functions of each apparatus or device may be performed by a cloud server.

At least part of each embodiment described above and the modification described above may appropriately be combined.

It should be thought that the embodiments are described herein by way of example in all aspects and are not restrictive. The scope of the present disclosure is not shown by the meaning described above but is shown by the scope of claims and includes all modifications having the equivalent meaning and scope to those of the claims.

### REFERENCE SIGNS LIST

1 terminal device
2 path-finding server
3 provision server
4 delivery server
5 vehicle
6 network
10 CPU
11 communication unit
12 storage unit
13 request unit
14 path-information-acquiring unit
15 provision-target-information-acquiring unit
16 display control unit
17 reservation-processing unit
18 payment-processing unit
19 input-receiving unit
20 CPU
21 communication unit
22 storage unit
22a charging stand information
22b facility information
22c reservation status information
23 path-finding unit
24 search unit
25 update unit
30 CPU
31 communication unit
32 storage unit
33 preparation-processing unit
34 request unit
35 determination unit
40 CPU
41 communication unit
42 storage unit
43 transport-processing unit
50 map
51 path
52 provision target information
53 provision target information
54 provision target information
55 provision target information
61 amount of remaining charge
62 amount of remaining charge
63 amount of remaining charge
100 provision-target-searching system

1. A provision target search method comprising:
a step of finding a path that extends from a first point to a second point via a waypoint that is a charging facility at which a vehicle is charged, based on the first point, the second point, and an amount of remaining power of a drive battery that is included in the vehicle; and
a step of searching for a provision target that is providable to a passenger of the vehicle during charging of the vehicle at the waypoint, based on facility information that represents the provision target that is a product or service that is providable at the charging facility.

2. The provision target search method according to claim 1, wherein the step of finding the path includes finding the path that extends via the waypoint for charging under a constraint that the amount of remaining power does not become less than a predetermined power threshold.

3. The provision target search method according to claim 1, wherein the step of finding the path further includes calculating a charging time during which the vehicle is charged at the waypoint, and
wherein the step of searching for the provision target further includes searching for the provision target, based on the charging time and a consumption time that is consumed to provide the provision target.

4. The provision target search method according to claim 1, wherein the step of searching for the provision target further includes searching for the provision target, based on an advertising cost of the provision target.

5. The provision target search method according to claim 1, further comprising: a step of displaying the path and the provision target on a display screen.

6. The provision target search method according to claim 1, further comprising:
a step of accepting a reservation for the provision target from a predetermined user; and
a step of notifying a provider who provides the provision target of the provision target that is reserved and an estimated time of arrival at the charging facility at which the provision target is providable.

7. The provision target search method according to claim 6, wherein the step of finding the path further includes finding a path that extends from a current position to the second point via the waypoint that is the charging facility at which the provision target that is reserved by the predetermined user is providable, based on the current position of the vehicle.

8. The provision target search method according to claim 6, wherein the step of notifying the provider includes, in a case where the estimated time of arrival is changed, again notifying the provider of a changed estimated time of arrival.

9. The provision target search method according to claim 6, further comprising:
a step of accepting a change in the provision target from the predetermined user; and
a step of notifying the provider of a provision target changed.

10. The provision target search method according to claim 6, further comprising:
a step of accepting a change in the second point from the predetermined user,
wherein the step of finding the path includes, in a case where the change in the second point is accepted, again finding a path that extends to the second point via the waypoint that is the charging facility at which the provision target is providable.

11. A provision target display method comprising:
a step of notifying a server of a first point, a second point, and an amount of remaining power of a drive battery that is included in a vehicle;
a step of acquiring, from the server, a path that extends from the first point to the second point via a waypoint that is a charging facility at which the vehicle is charged, the path being found based on the first point, the second point, and the amount of remaining power;
a step of acquiring, from the server, information about a provision target that is a product or service that is providable to a passenger of the vehicle during charging of the vehicle at the waypoint; and
a step of displaying the path and the provision target.

12. The provision target display method according to claim 11, wherein the step of acquiring the path includes acquiring the path that extends via the waypoint for charging and that is found under a constraint that the amount of remaining power does not become less than a predetermined power threshold.

13. The provision target display method according to claim 11, wherein the step of acquiring the information about the provision target includes acquiring the information about the provision target by searching based on a charging time of the vehicle at the waypoint and a consumption time that is consumed to provide the provision target.

14. The provision target display method according to claim 11, wherein the step of acquiring the information about the provision target includes acquiring the information about the provision target by searching based on an advertising cost of the provision target.

15. The provision target display method according to claim 11, further comprising:
a step of accepting a reservation for the provision target from a predetermined user; and
a step of notifying a provider who provides the provision target of the provision target that is reserved and an estimated time of arrival at the charging facility at which the provision target is providable.

16. The provision target display method according to claim 15, further comprising: a step of notifying the server of a current position of the vehicle,
wherein the step of acquiring the path further includes acquiring, from the server, a path that extends from the current position to the second point via the waypoint that is the charging facility at which the provision target that is reserved by the predetermined user is providable.

17. The provision target display method according to claim 15, wherein the step of notifying the provider includes, in a case where the estimated time of arrival is changed, again notifying the provider of a changed estimated time of arrival.

18. The provision target display method according to claim 15, further comprising:
a step of accepting a change in the provision target from the predetermined user; and
a step of notifying the provider of a provision target changed.

19. The provision target display method according to claim 15, further comprising:
a step of notifying the server of a second point that is changed by a user input,
wherein the step of acquiring the path includes, in a case where the second point is changed, again acquiring a path that extends to the second point via the waypoint that is the charging facility at which the provision target is providable.

20. A provision-target-searching apparatus comprising:
a finding unit that finds a path that extends from a first point to a second point via a waypoint that is a charging facility at which a vehicle is charged, based on the first point, the second point, and an amount of remaining power of a drive battery that is included in the vehicle; and
a search unit that searches for a provision target that is providable to a passenger of the vehicle during charging of the vehicle at the waypoint, based on facility information that represents the provision target that is a product or service that is providable at the charging facility.

21. A provision-target-displaying apparatus comprising:
a notification unit that notifies a server of a first point, a second point, and an amount of remaining power of a drive battery that is included in a vehicle;
a path-acquiring unit that acquires, from the server, a path that extends from the first point to the second point via a waypoint that is a charging facility at which the vehicle is charged, the path being found based on the first point, the second point, and the amount of remaining power;
a provision-target-information-acquiring unit that acquires, from the server, information about a provision target that is a product or service that is providable to a passenger of the vehicle during charging of the vehicle at the waypoint; and
a display control unit that causes the path and the provision target to be displayed on a display screen.

22. A provision-target-searching system comprising:
a provision-target-searching apparatus; and
a provision-target-displaying apparatus,
wherein the provision-target-searching apparatus includes
a finding unit that finds a path that extends from a first point to a second point via a waypoint that is a charging facility at which a vehicle is charged, based on the first point, the second point, and an amount of remaining power of a drive battery that is included in the vehicle, and
a search unit that searches for a provision target that is providable to a passenger of the vehicle during charging of the vehicle at the waypoint, based on facility information that represents the provision target that is a product or service that is providable at the charging facility, and
wherein the provision-target-displaying apparatus includes
a notification unit that notifies the provision-target-searching apparatus of the first point, the second point, and the amount of remaining power of the vehicle,
a path-acquiring unit that acquires the path from the provision-target-searching apparatus,
a provision-target-information-acquiring unit that acquires a result of searching for the provision target from the provision-target-searching apparatus, and
a display control unit that causes the path and the provision target to be displayed on a display screen.

23. (canceled)

24. (canceled)
